(19) United States
(12) Patent Application Publication
(10) Pub. No.: US 2012/0169459 A1
(43) Pub. Date: Jul. 5, 2012

(54) SYSTEM AND METHOD FOR PASSIVELY ACQUIRING EXISTING CUSTOMERS' MOBILE PHONE NUMBERS FROM CUSTOMER SERVICE LOGS

(75) Inventor: Matthew J. Gillin, Villanova, PA (US)

(73) Assignee: RELAY HOLDINGS, LLC, Radnor, PA (US)

(21) Appl. No.: 12/983,745

(22) Filed: Jan. 3, 2011

(51) Int. Cl. G06F 7/04

(52) U.S. Cl. 340/5.8

(57) ABSTRACT

An entity passively acquires an existing customer's mobile phone number and links the customer's mobile phone number to the customer's account without requesting the customer to actively provide customer identifying information. This is accomplished by capturing the customer's mobile phone number when the customer uses a mobile phone to contact the entity and checking whether the captured mobile phone number is in a customer database. If the captured mobile phone number is not in the customer database, the customer using the mobile phone number may be validated by determining that the customer corresponds to a particular customer account and associating the captured mobile phone number with the particular customer account. For example, the validation of the customer may include analyzing entries in the service log to identify phone numbers, determining whether the identified phone numbers are mobile numbers or landline numbers, determining who the identified phone numbers belong to, and determining whether the identified person corresponds to an account in the customer database. If the captured mobile phone number is in the customer database, the customer using the mobile phone number may be validated against the corresponding customer account record to establish a confidence score.

### CROSS-REFERENCE TO RELATED APPLICATIONS

The present application is related by subject matter to the invention described in U.S. patent application Ser. No. 12/709,312, filed Feb. 19, 2010. The subject matter of that application is hereby incorporated by reference in its entirety.

### FIELD OF THE INVENTION

The present invention relates to an electronic system and method for an entity to passively acquire existing customers' mobile phone numbers and, more particularly, to a system and method for enabling an entity to acquire customer's mobile phone numbers from customer service logs and to use the acquired numbers and addresses to invite the customers to enroll in services offered by the entity.

### BACKGROUND

Many businesses would like to communicate with their customers electronically but are unable to do so because they do not have electronic contact information for their customers. For example, a utility company may wish to send bills to its customers via SMS text messaging; however, the utility company is unable to do so because it does not have mobile phone numbers for its customers or it has mobile numbers but is not sure if they are correct. Because these businesses are unable to communicate with their customers in this fashion, these businesses are forced to communicate with their customers via more costly and inefficient channels, such as by regular mail or by landline telephone.

To address this issue, some businesses have attempted to gather electronic contact information for their customers by allowing their customers to create electronic accounts, by contacting their customers to request electronic contact information, or by requiring their customers to provide electronic contact information. Unfortunately, such efforts may require a lot of time and money and may not produce the desired results. Furthermore, such efforts may require active participation of customers who may not have an incentive to provide the requested electronic contact information.

Related U.S. patent application Ser. No. 12/709,312, filed Feb. 19, 2010, provides techniques by which an entity may passively gather contact information about its customers and may use this information to communicate with such customers more effectively. For example, the system described in that application captures information about the entity's customers and compares the information to a database to identify any similarities with stored data for known persons. If the information is found to have a confidence score above a threshold level, then the person may be positively identified. If the customers' cell phone numbers may be acquired in this fashion, then the entity is enabled to communicate with its customers using SMS text messaging. However, the methods described therein overlook one useful source by which an entity may passively acquire contact information for its customers—the company's service log of service activation and other service requests in connection with existing customer accounts. A technique is desired by which this service call log data may be acquired and matched to existing customer data to provide additional information about the entity's customers to further enhance the confidence score and to enable, for example, SMS text messaging with the entity's customers. The present invention addresses this need in the art.

### SUMMARY

The above-referenced need in the art is addressed by providing a system and method for enabling an entity to passively acquire an existing customer's mobile phone number and to link the customer's mobile phone number to the customer's account without requesting the customer to actively provide customer identifying information. In an exemplary embodiment, this is accomplished by capturing the customer's mobile phone number when the customer uses a mobile phone to contact the entity and by checking whether the captured mobile phone number is in a customer database. If the captured mobile phone number is not in the customer database, the customer using the mobile phone number may be validated by determining that the customer corresponds (within a particular degree of confidence) to a particular customer account and associating the captured mobile phone number with the particular customer account. If the captured mobile phone number is in the customer database, the customer using the mobile phone number also may be validated against the corresponding customer account record to establish a confidence score. For example, the validation of the customer may include analyzing entries in a service log to identify phone numbers, determining whether the identified phone numbers are mobile numbers or landline numbers, determining who the identified phone numbers belong to, and determining whether the identified person corresponds to an account in the customer database. Once the customer's mobile phone number has been acquired, the entity may then send an invitation to the customer using the customer's captured mobile phone number to enroll the customer in a service offered by the entity (e.g., correspondence by SMS text messaging). The acquired data in the customer database may also be used to enhance the confidence score of the matching network used to identify the customer from his/her identifying information.

In an exemplary embodiment, the customer's mobile phone number is captured in a service log along with the customer's account identification when the customer contacts the entity's call center by phone or service center by phone. Then, the captured phone number is checked against the customer database by comparing phone numbers stored in the service log against phone numbers stored in the customer's account file identified by the customer's account identification. The captured phone numbers may also be compared against a database of phone numbers to identify the customer corresponding to the captured phone number and the captured phone number may then be provided to the identified customer's account file.

The systems and methods in accordance with the invention also include evaluating service log data in connection with account information to validate the type and relationship of call-in numbers to respective accounts. In this case, the service log data is received from an entity associated with the respective accounts. Preferably, the service log stores inbound phone numbers and links these phone numbers to corresponding account numbers of the respective accounts. The service log data is matched to a database of customer phone numbers to link accounts of respective customers to phone numbers in the service log. Then, if an inbound phone number in the service log is not in any entries of the database of customer numbers, a mobile number directory is searched to identify the person corresponding to the inbound phone number and the inbound phone number is associated to the person's customer account with the entity. The entity may provide a customer database so that the matching step may further include matching inbound phone numbers in the service log with phone numbers in the customer database to link customer accounts with inbound phone numbers in the service log and providing matched inbound phone numbers to corresponding customer accounts in the customer database. The matching may further include analyzing entries in the service log to identify phone numbers, determining whether the identified phone numbers are mobile numbers or landline numbers, determining who the identified phone numbers belong to, and determining whether the identified person corresponds to an account in the customer database. This information may also be analyzed to enhance the confidence score when matching the person to client accounts and mobile phone numbers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Exemplary embodiments of the invention will be described in connection with the associated figures, of which:

FIG. 1 illustrates an example embodiment of a system for analyzing an entity's service log in connection with the entity's customer files and a mobile number directory to identify mobile numbers for customers in the customer file and to provide a report and/or the customer file with mobile numbers identified back to the entity.

FIG. 2 illustrates an example embodiment of a method for linking the service log information to the customer files in accordance with the invention.

FIG. 3 illustrates the example of FIG. 2 in more detail, including the process of linking the mobile numbers to the customers' accounts in accordance with the invention.

### DETAILED DESCRIPTION OF ILLUSTRATIVE EMBODIMENTS

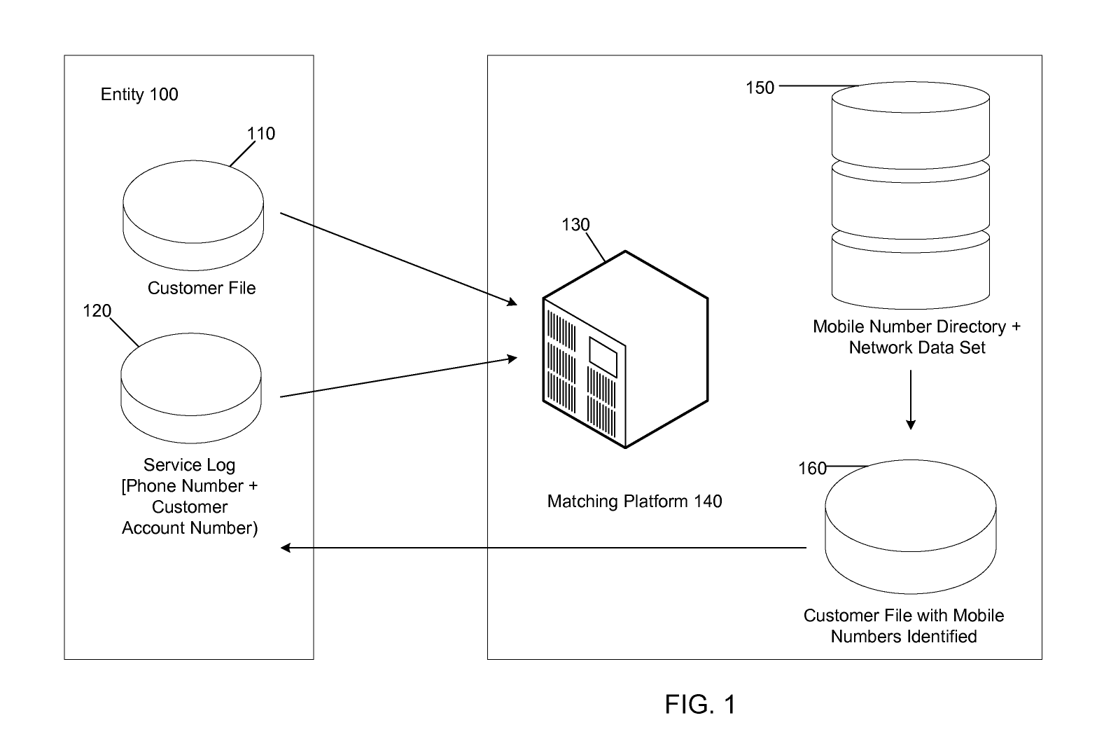

A detailed description of illustrative embodiments of the present invention will now be described with reference to FIGS. 1-3. Although this description provides a detailed example of possible implementations of the present invention, it should be noted that these details are intended to be exemplary and in no way delimit the scope of the invention.

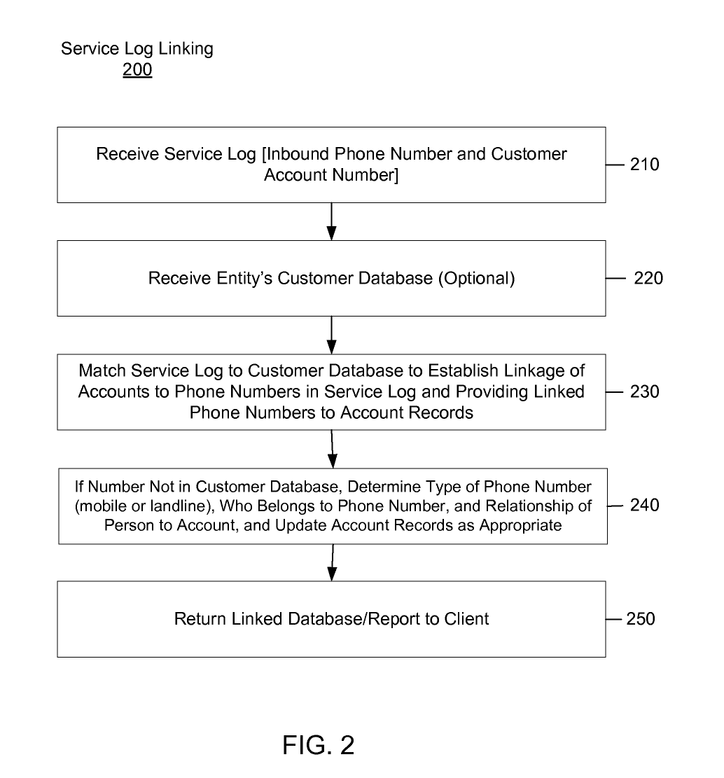

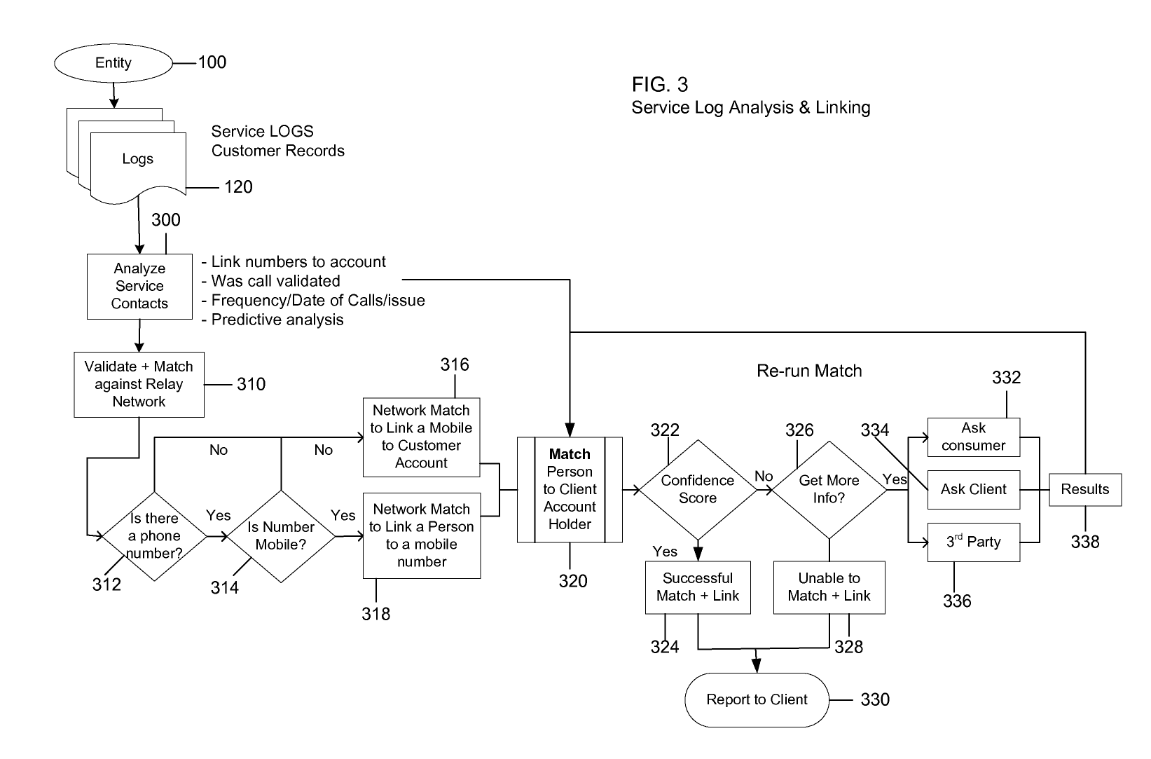

FIG. 1 illustrates an example embodiment of a system for analyzing an entity's service log in connection with the entity's customer files and a mobile number directory to identify mobile numbers for customers in the customer file and to provide a report and/or the customer file with mobile numbers identified back to the entity. As illustrated, an entity 100 provides its customer file data 110 and service log data 120 including, for example, interactive voice response (IVR) call log data (including phone numbers and customer account numbers to which the calls were directed) and/log data to a server 130 of a matching platform 140. The matching platform 140 includes, in addition to server 130, a mobile number directory and network data set 150 including mobile numbers as generated, for example, in the above-referenced related U.S. patent application Ser. No. 12/709,312. As explained therein, this directory may be used to satisfactorily identify the persons affiliated with the numbers and addresses in the customer files 110 and service log 120. In an exemplary embodiment, the customer files 110 are modified to include the identified mobile numbers for the identified customers and the modified customer files 160 are returned to the entity 100. On the other hand, a report identifying the updated information may be generated and provided to entity 100. In addition, the collected information may be used to augment the data in the directory and network data set 150 for use in future comparisons by the matching platform 140. Further details of the operation of the matching platform 140 will be described below with respect to FIGS. 2 and 3.

Those skilled in the art will appreciate that the matching platform 140 may include a computing environment implemented by a computer, a mainframe, a server, or the like. According to the illustrated embodiment, the computing environment includes server 130 having hardware components and/or software components such that the resulting computing environment may be used to execute applications such as internet applications, operating systems, server applications, client applications, database applications, or the like. For example, the computing environment on server 130 may be used to execute software application programs implementing the methods described below with respect to FIGS. 2 and 3.

In an example embodiment, the server 130 of the matching platform 140 includes a processor that may be in operative communication with an instruction memory (both not shown) with instructions for implementing an operating system and application programs for implementing the matching techniques of the invention. The processor may include a standardized processor, a specialized processor, a microprocessor, or the like. The processor executes instructions including, for example, instructions for creating address profiles, sending electronic communications, or any other suitable instruction, which will be described in more detail below.

The instruction memory of server 130 stores the instructions that may be executed by the processor of the server 130. The instruction memory may include computer readable storage media in the form of volatile and/or nonvolatile memory such as random access memory (RAM), read only memory (ROM), cache, Flash memory, a hard disk, or any other suitable storage component. In one embodiment, the instruction memory may be a separate component in communication with the matching platform and/or the processor of the server 130, while in another embodiment, the instruction memory may be integrated into the processor.

As shown in FIG. 1, the matching platform 140 may be in communication with entity 100 via communication links that may be a wired connection including, for example, a USB connection, a Firewire connection, an Ethernet cable connection, or the like and/or a wireless connection such as a wireless 802.11b connection, a radio connection, a cell phone connection, or the like.

FIG. 2 illustrates an example embodiment of a method for linking the service log information to the customer files in accordance with the invention. FIG. 2 represents methods that may be implemented in software application programs on server 130, for example. As indicated in FIG. 2, the service log linking method 200 includes receiving the service log 120 from the entity 100 at step 210 and (optionally) receiving the customer file (database) 110 of entity 100 at 220. As 230, the service log data is matched to the customer database 110 to establish linkage of the accounts in the customer database 110 to phone numbers in the service log 120. However, if a phone number in the service log 120 is not in the customer database 110, the type of phone number (landline or mobile) is determined at 240. At 240, who belongs to the phone number is also determined using, for example, the techniques described in related U.S. patent application Ser. No. 12/709,312, and the relationship of that person to the customer accounts is also determined. Any new information obtained in this fashion may then be used to update the customer file 110 to create updated customer file 160 or a report, as appropriate. Any data in the log may also be used to modify the confidence score for establishing the identity of the person identified by the account data. The updated/linked customer database 160 may then be returned to the entity 100 and/or a report may be generated and provided to the entity 100 at 250, as appropriate.

FIG. 3 illustrates the example of FIG. 2 in more detail, including the process of linking the mobile numbers to the customers' accounts in accordance with the invention. As illustrated in FIG. 3, entity 100 provides its service logs and customer records 120 to matching platform 140. As known to those skilled in the art, the service logs 120 typically include the call-in number of the customer, the account number to which the call/was directed, the phone number(s) on the corresponding account, the service issue (purpose of the contact), whether the call was validated and the length of the call or session. In total, the service logs 120 identify whether the calls from a particular number were validated, how many calls were received from each number, the type of the calls, when the calls occurred, and whether the calls were linked to the customers' accounts. This service log data is analyzed at 300 to link the numbers in the service log to the corresponding account and, as appropriate, to further enhance the confidence score and/or the base level weighting of the network identification data stored for the individual from which the calls were received. Other analysis may also be performed, such as ranking the service calls by frequency and issue addressed as well as for predictive analysis of service issues. The results of this analysis feed the match process and provide helpful input into the confidence score of the match network 320.

The phone numbers in the service log 120 that are not accounted for in the customer files 110 are identified at 310 and then analyzed at 316 and 318 against network directory 150 based on whether a phone number is identified at 312 and whether a mobile phone number is identified at 314. Based on the results of the matches at 316 and 318, the data in the log is matched to a known individual (or not) at 320. For example, if a sufficient confidence score for matching the log data to an individual is determined at 322, then a successful match is found at 324 and a report to that effect is issued at 330 indicating that the identified number can be identified. On the other hand, if the customer cannot be identified from the log data, more information is requested at 326. If no more data is determined to be available and/or no match is found at 328, a report to that effect is issued at 330 indicating that a number in the call log cannot be matched to an individual. However, if more information is available, such information is gathered from the consumer at 332, the client at 334, and/or a third party at 336. The results 338 of the information gathering are fed back to the match network 320 for another attempt at identifying the individual using the new information. This process repeats until the person is identified or the person cannot be identified from the available data. Preferably, the techniques described in U.S. patent application Ser. No. 12/709,312 are used for the illustrated matching process. In addition to report 330, the customer database 110 may also be updated to produce customer file 160 including the newly discovered information (FIG. 1), as appropriate.

Those skilled in the art also will readily appreciate that these and many additional modifications are possible in the exemplary embodiment without materially departing from the novel teachings and advantages of the invention. For example, the system described herein may be used to leverage the mobile number directory and network data set 150 generated during the matching process described in U.S. patent application Ser. No. 12/709,312 to further supplement the contact information for customers of a business. This may be done to, for example, allow a utility company to enroll its customers into an electronic billing system without requiring the utility company customers to provide electronic contact information. In one example embodiment, the utility company may have a database that includes physical addresses, account numbers, and names for its customers; however, the utility company does not have any electronic contact information for its customers. The service log of the utility company may be used to provide additional mobile and/or landline numbers to the company's customer database. The updated address profiles including the e-mail addresses and/or mobile phone numbers identified in the service logs may then be used by the utility company to send its customers SMS text messages asking them if they would like to receive electronic bills on their cell phone or to be communicated with electronically. Additionally, the utility company may transmit electronic bills to the customers' cell phones or computers. Accordingly, any such modifications are intended to be included within the scope of this invention as defined by the following exemplary claims.

What is claimed:

1. A method for an entity to passively acquire an existing customer's mobile phone number and/and to link the customer's mobile phone number to the customer's account without requesting the customer to actively provide customer identifying information, comprising the steps of:
capturing the customer's mobile phone number when the customer uses a mobile phone to contact the entity;
checking whether the captured mobile phone number is in a customer database; and
validating that the customer using the mobile phone number that corresponds to the customer of a particular customer account and associating the captured mobile phone number with the particular customer account.

2. A method as in claim 1, wherein the customer's mobile phone number is captured in a service log along with the customer's account identification when the customer contacts the entity's call center or service center.

3. A method as in claim 2, wherein checking whether the captured phone number is in the customer database comprises comparing phone numbers stored in the service log against phone numbers stored in the customer's account file identified by the customer's account identification.

4. A method as in claim 3, further comprising comparing captured phone numbers that are not identified as being in said customer's account file against a database of phone numbers to identify the customer corresponding to the captured phone number and providing the captured phone number to the identified customer's account file.

5. A method as in claim 1, wherein said checking and validating steps comprise analyzing entries in the service log to identify phone numbers, determining whether the identified phone numbers are mobile numbers or landline numbers, determining who the identified phone numbers belong to, and determining whether the identified person corresponds to an account in the customer database.

6. A method of evaluating service log data in connection with account information to validate the type and relationship of call in numbers to respective accounts, comprising the steps of:
receiving service log data from an entity associated with said respective accounts, said service log storing inbound phone numbers and linking same to corresponding account numbers of said respective accounts;
matching the service log data to a database of customer numbers to link accounts of respective customers to phone numbers in the service log; and
if an inbound phone number in said service log is not in any entries of said database of customer numbers, searching a mobile number directory to identify the person corresponding to the inbound phone number and associating the inbound phone number to the person's customer account with the entity.

7. A method as in claim 6, further comprising receiving a customer database from said entity, wherein said matching step comprises matching inbound phone numbers in said service log with phone number in said customer database to link customer accounts with inbound phone numbers in said service log.

8. A method as in claim 7, further comprising providing matched inbound phone numbers to corresponding customer accounts in said customer database.

9. A method as in claim 6, wherein said matching step comprises analyzing entries in the service log to identify phone numbers, determining whether the identified phone numbers are mobile numbers or landline numbers, determining who the identified phone numbers belong to, and determining whether the identified person corresponds to an account in the customer database.

10. A server programmed to enable an entity to passively acquire an existing customer's mobile phone number and to link the customer's mobile phone number to the customer's account without requesting the customer to actively provide customer identifying information, said server including a processor that processes instructions for implementing the steps of:
capturing the customer's mobile phone number when the customer uses a mobile phone to contact the entity;
checking whether the captured mobile phone number is in a customer database; and
validating that the customer using the mobile phone number and/corresponds to the customer of a particular customer account and associating the captured mobile phone number and/with the particular customer account.

11. A server as in claim 10, wherein the customer's mobile phone number is received in a service log along with the customer's account identification, said service log capturing the mobile phone number when the customer contacts the entity's call center or service center.

12. A server as in claim 11, wherein the processor checking whether the captured phone number is in the customer database comprises the processor comparing phone numbers stored in the service log against phone numbers stored in the customer's account file identified by the customer's account identification.

13. A server as in claim 12, further comprising the processor comparing captured phone numbers that are not identified as being in said customer's account file against a database of phone numbers to identify the customer corresponding to the captured phone number and the processor providing the captured phone number to the identified customer's account file.

14. A server as in claim 10, wherein the checking and validating steps comprise the processor analyzing entries in the service log to identify phone numbers, determining whether the identified phone numbers are mobile numbers or landline numbers, determining who the identified phone numbers belong to, and determining whether the identified person corresponds to an account in the customer database.

15. A server programmed to evaluate service log data in connection with account information to validate the type and relationship of call in numbers to respective accounts, said server including a processor that processes instructions for implementing the steps of:
receiving service log data from an entity associated with said respective accounts, said service log storing inbound phone numbers and linking same to corresponding account numbers of said respective accounts;
matching the service log data to a database of customer phone numbers to link accounts of respective customers to phone numbers in the service log; and
if an inbound phone number in said service log is not in any entries of said database of customer phone numbers, searching a mobile number directory to identify the person corresponding to the inbound phone number and associating the inbound phone number to the person's customer account with the entity.

16. A server as in claim 15, wherein said processor further receives a customer database from said entity and said processor matches inbound phone numbers in said service log with phone numbers in said customer database to link customer accounts with inbound phone numbers in said service log.

17. A server as in claim 16, wherein said processor further provides matched inbound phone numbers to corresponding customer accounts in said customer database.

18. A server as in claim 15, wherein said processor performs said matching by analyzing entries in the service log to identify phone numbers, determining whether the identified phone numbers are mobile numbers or landline numbers, determining who the identified phone numbers belong to, and determining whether the identified person corresponds to an account in the customer database.
